(19) United States
(12) Patent Application Publication
(10) Pub. No.: US 2024/0407043 A1
(43) Pub. Date: Dec. 5, 2024

(54) CONDITIONAL DEVICE PAGING IN DISCONTINUOUS RECEPTION (DRX)

(71) Applicant: Nokia Technologies Oy, Espoo (FI)

(72) Inventors: Alba JANO, Munich (DE); Wolfgang KELLERER, Fuerstenfeldbruck (DE); Halit Murat GÜRSU, Munich (DE); Nitin MANGALVEDHE, Hoffman Estates, IL (US); Rapeepat RATASUK, Hoffman Estates Inverness, IL (US); Rakash SIVASIVA GANESAN, Unterhaching (DE)

(21) Appl. No.: 18/693,347

(22) PCT Filed: Sep. 27, 2021
(86) PCT No.: PCT/EP2021/076514

§ 371 Date: Mar. 19, 2024

(51) Int. Cl. H04W 76/28; H04W 52/02; H04W 68/02

(52) U.S. Cl. CPC H04W 76/28; H04W 52/0229; H04W 68/02

(57) ABSTRACT

Various techniques are provided for a method including broadcasting, by a network node, a discontinuous reception (DRX) switch message indicating a user equipment (UE) is to switch from a first DRX cycle to a second DRX cycle and determining, by the network node, whether to send a paging message to the UE using one of the first DRX cycle or the second DRX cycle. The method can further include determining, by the network node, that the network node is in a reduced resource state.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a device, a system, a non-transitory computer-readable medium (having stored thereon computer executable program code which can be executed on a computer system), and/or a method can perform a process with a method including broadcasting, by a network node, a discontinuous reception (DRX) switch message indicating a user equipment (UE) is to switch from a first DRX cycle to a second DRX cycle. In step S720 determining, by the network node, whether to send a paging message to the UE using one of the first DRX cycle or the second DRX cycle.

The details of one or more examples of embodiments are set forth in the accompanying drawings and the description below. Other features will be apparent from the description and drawings, and from the claims. The method can further include determining, by the network node, that the network node is in a reduced resource state. The reduced resource can include at least one of a resource unavailability to support a required coding or modulation rate for communication with the UE, the network having a limited amount of radio resources, and the network having limited backhaul resources. The method can further include receiving, by the network node, an indication that the UE is configured to monitor the paging message using the second DRX cycle. The network node can be a radio access network (RAN) node or a mobility management function (AMF). The indication that the UE is configured to monitor the paging message using the second DRX cycle can be received from the UE as an ACK message. The indication that the UE is configured to monitor the paging message using the second DRX cycle can be received at an AMF as one of a configuration update message. The indication that the UE is configured to monitor the paging message using the second DRX cycle can be received at an AMF as a UE context update message.

The DRX switch message can be a first DRX switch message, the method can further include determining, by the network node, that the network node is no longer in a reduced resource state and broadcasting, by the network node, a second DRX switch message indicating the UE is to switch from the second DRX cycle to the first DRX cycle. The DRX switch message can be a first DRX switch message, the method can further include determining, by the network node, whether the UE has received one of the first DRX switch message or a second DRX switch message, determining, by the network node, whether the UE is monitoring the paging message using the first DRX cycle or the second DRX cycle, in response to determining the UE is using the second DRX cycle, the sending of the paging message to the UE uses the second DRX cycle, in response to determining the UE is using the first DRX cycle, the sending of the paging message to the UE uses the first DRX cycle, and rebroadcasting, by the network node, one of the first DRX switch message indicating the UE is to switch from the first DRX cycle to the second DRX cycle or the second DRX message indicating the UE is to switch from the second DRX cycle to the first DRX cycle. The broadcasting of the first DRX switch message or the second DRX switch message can include sending a message indicated as part of a system information update indication. The first DRX cycle and the second DRX cycle can be preconfigured in the UE by the network node while the UE is in an RRC active state. The UE can be pre-configured to monitor the DRX switch message. The method can further include communicating, to an AMF, that the UE has switched to the second DRX.

### BRIEF DESCRIPTION OF THE DRAWINGS

FIG. 1 is a block diagram of a wireless network according to an example embodiment.

FIG. 2 is a block diagram of a method of operating a network according to an example embodiment.

FIG. 3A is a flow diagram illustrating a DRX modification in a network according to an example embodiment.

FIG. 3B is a flow diagram illustrating a DRX modification in a network according to an example embodiment.

FIG. 3C is a flow diagram illustrating a DRX modification in a network according to an example embodiment.

FIG. 4 is a flow diagram illustrating a DRX modification in a network according to an example embodiment.

FIG. 5 is a flow diagram illustrating a DRX modification in a network according to an example embodiment.

FIG. 6 is a flow diagram illustrating a DRX modification in a network according to an example embodiment.

FIG. 7 is a block diagram illustrating a method for operating a network node according to an example implementation.

FIG. 8 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

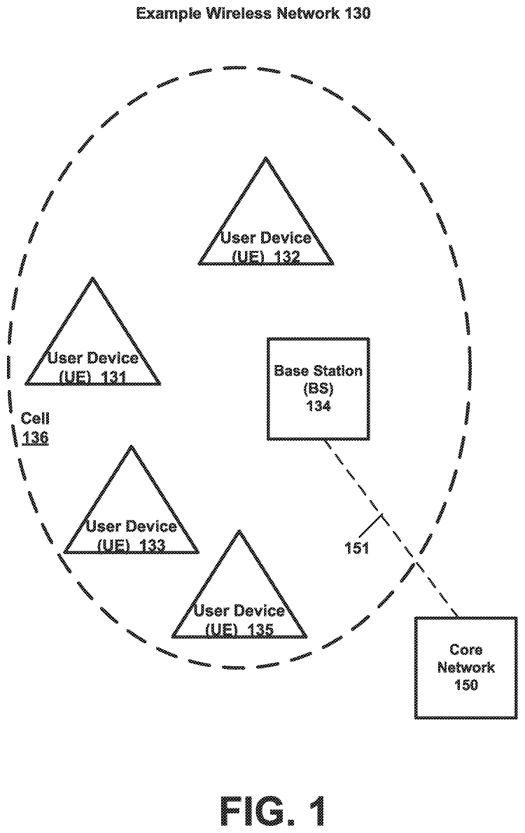

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (c) Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

In a connected mode (e.g., RRC-Connected) with respect to a cell (or gNB or DU), the UE is connected to a BS/gNB, and the UE may receive data, and may send data (based on receiving an uplink grant). Also, in a connected mode, UE mobility (e.g., determining which cell serves a UE that may be mobile) may be controlled by the gNB or network.

In order to conserve power, a UE may, for example, transition from a connected state (e.g., RRC Connected) to an unconnected state, such as an Idle state (e.g., RRC Idle) or Inactive state (e.g., RRC Inactive), e.g., in which the UE may sleep (a low power state) much of the time while in Idle or Inactive state. In Idle state or Inactive state, the UE does not have a connection established with any cell, and mobility (e.g., determining which cell the UE will be camped on or which cell to select as the cell from which to monitor signals for the UE) is controlled by the UE. Inactive state (e.g., RRC Inactive) may also be referred to as a suspended state of the UE. While in Idle state or Inactive state, the UE may sleep much of the time, and then periodically wake (e.g., changing from a low power state to a full-power state) to perform one or more tasks or processes, e.g., such as receiving system information from the cell the UE may be camped on (the cell from which to monitor signals and messages for the UE while in Idle state or Inactive state and with which the UE will attempt to initiate a connection when necessary), monitoring a control channel for a paging message, detecting a paging message (a paging message detected by the UE may indicate that the network has data for downlink transmission to the UE), performing measurements, and/or performing a cell search and cell reselection process in which the UE may measure reference signals from various cells, and then select a cell (or reselect the same cell) to camp on, based on the received signals from various cells. Thus, as an example, cell selection may include selecting a cell that has a strongest reference signal received power (RSRP) and/or reference signal received quality (RSRQ), or other signal parameter. For example, a UE may typically receive system information (e.g., via receiving one or more broadcast system information blocks (SIBs)) from the cell the UE is camping on while the UE is awake in Idle state or Inactive state.

As noted, when a UE is in Idle state, there is no RRC context (the parameters necessary for communication between the UE and network) for the UE stored by the radio access network (BS/gNB) or UE. No uplink synchronization is maintained by the UE, and generally no data transfer may take place, as the UE sleeps most of the time to conserve battery consumption. The UE may wake periodically to monitoring a control channel for a paging message, receive paging messages and perform cell reselection, based on reference signal measurements. UE mobility is handled by the UE via cell reselection. An uplink transmission that may be performed by the UE in Idle mode is via the random access (RACH) procedure or messages, that may be used for the UE to transition from Idle state to Connected state with respect to a cell or gNB.

In Inactive state, (at least some) RRC context for the UE is stored at both the UE and the gNB, e.g., to allow the UE to more quickly transition from Inactive state to Connected state, e.g., since at least some RRC context for the UE may already be in place at the UE and the gNB (e.g., such as an inactive-radio network temporary identifier (I-RNTI) assigned to the UE). At the same time, the Inactive UE is allowed to sleep (or enter a low power state), and periodically wake to monitor and receive paging messages and/or perform cell reselection, e.g., in a same or similar manner as Idle state.

Reduced capability UEs (a special class or type or category of UEs) can have lower device cost and complexity as compared to high-end eMBB and URLLC devices. Moreover, in most use cases a device should support all FR1/FR2 bands for FDD and TDD. The intended use cases for reduced capability UEs can include, for example, industrial wireless sensors, video surveillance, wearables, and the like. These reduced capability (RedCap) UEs can have an increased battery life and/or maintaining of charge requirements. For example, the battery should last at least few years for industrial wireless sensors and/or the battery of the device should last multiple days (up to 1-2 weeks) for wearables.

The RRC-Inactive state can enable a reduction of energy consumption and increase battery efficiency while the device stays in RRC-Inactive state, a reduction of the delay caused when device needs to access the system and start the data transmission after inactivity periods, and a reduction of the signaling overhead in the Radio and the Core Network (CN)/RAN interfaces for devices coming from inactivity periods that want to transmit small amounts of data (e.g., MTC devices) or short data bursts (e.g., some types of smartphone traffic). In NR, RedCap devices can have aforementioned battery requirements. Reducing continuous monitoring of the PDCCH channel(s) can be a factor in decreasing the RedCap device energy efficiency. The RRC Resume procedure, where devices transition from RRC-Inactive to RRC-Connected state, includes PDCCH channel monitoring during paging frames (PFs) and paging occasions (POs) to receive downlink messages from the gNB.

The RRC Resume procedure can be triggered by paging messages, where devices monitor the PDCCH channel for paging messages (e.g., downlink control information scheduling paging messages). For a successful RRC Resume procedure the UE needs no contention for RACH procedure with PRACH resources (e.g., each contention will delay the access and cause extra energy use) and available DL radio resources for the scheduling of the UE after a successful RACH procedure. For example, without any resource, the UE is to go back to RRC-Inactive state and retry at a later time. This can cause a RedCap UE to unnecessarily use energy (thus reducing battery charge). Further, the channel quality may degrade at certain times of the day due to some transient mobility or weather condition. This can cause energy efficiency to decrease (thus reducing battery charge).

These are example of problems in the current technology that can minimize a UEs ability to extend battery life and/or maintaining of charge. Example embodiments seek to reduce the effect of the RRC Resume procedure by avoiding paging the UE during the overload situation associated with availability of DL radio resources and/or a degraded channel quality. Example embodiments can enable the RAN to reduce a discontinuous reception (DRX) paging cycle which can minimize the amount of time the UE enters the RRC Resume procedure.

Example implementations enable a conditional device paging DRX, which changes the number of PFs and POs based on the context of the network, environment and devices. The conditional device paging DRX refers to the conditional device type-specific paging DRX or conditional device-specific paging DRX. gNB decides if the conditional device paging DRX is the former or the latter case. The conditional device type-specific paging DRX cycle configuration is identical for all the devices of a specific type, such as RedCap devices, which update the paging DRX after receiving an indication from the network. However, considering different applications running on RedCap devices, conditional device-specific paging DRX can be extended where the conditional DRX configuration could be different for each device, even though the devices might be the same type.

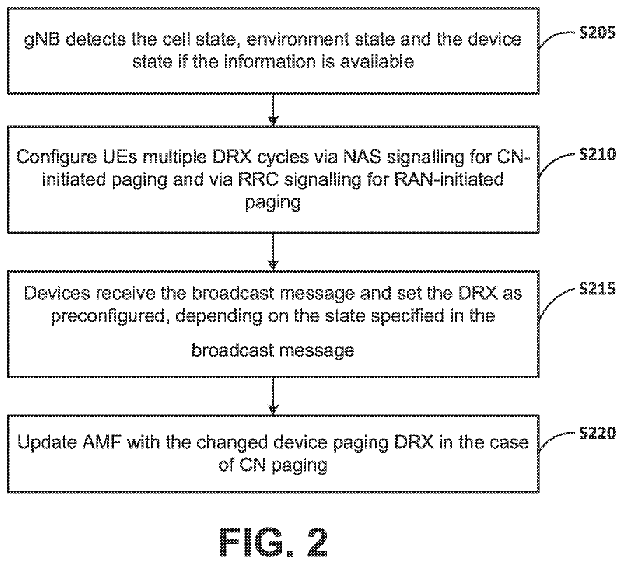

FIG. 2 is a block diagram of a method of operating a network according to an example embodiment. As shown in FIG. 2, in step S205 the gNB detects or determines the cell state, environment state and the device state if the information is available. The detection can include the lack of resources, bad channel quality, low battery level, and/or going again in the normal operation state, cause gNB to trigger a conditional paging DRX. For example, the gNB can broadcast a conditional device paging DRX message to all or a group of RedCap devices located in the specific cell. Some RedCap devices can be preconfigured to monitor this parameter. A change or return to initial values of the device can be specified in the paging DRX cycle. This message may be indicated as part of a system information update indication (e.g., direct indication sent on paging DCI).

In step S210 multiple DRX cycles are configured for UEs via NAS signalling for CN-initiated paging and via RRC signalling for RAN-initiated paging. The preconfigured device paging DRX can consist of default device DRX cycle values and one or more multiples of the default device DRX cycle values. In response to cell congestion, channel degradation or low battery level of devices, a broadcast message can be sent to trigger a larger device paging DRX cycle selection, thereby reducing the PDCCH monitoring. When resources are available, but the quality of the channel is not good, an increase of device paging DRX cycle can avoid the RRC Resume procedure execution for some time. After the resumption of normal operation state of the cell, devices or channel quality, a broadcast message can be sent to trigger the default device paging DRX selection. If devices fail to receive the broadcast message, the devices may not update the AMF with the device-specific paging DRX. Therefore, the device can proceed as the state of the art operation of CN and RAN paging. However, if the gNB updates the AMF in case of CN paging, the device monitors the PDCCH channel in the normal PFs and POs, but gNB transmits the paging message in multiples of PFs and POs. However, the device can still receive the paging messages.

In step S215 devices receive the broadcast message and set the DRX as preconfigured, based on the state specified in the broadcast message. The device can set the paging DRX cycle to have a longer period of time between initiating the RRC Resume procedure in response to the message.

In step S220 the AMF is updated with the changed device paging DRX in the case of CN paging. The AMF can be updated based on a message from the RAN or based on a message from the UE. Updating the AMF of the DRX cycle change can help with configuration information used in a handover procedure. If the device selects a different device paging DRX, the device updates the AMF using the Attach or Tracking Area Update procedures. The device can transition to RRC-Connected state during the execution of the procedures. However, if the context state triggering the conditional device paging DRX does not change frequently, the update of the AMF from the devices may not cause a high overhead of signaling and increase in the resource usage. The updated device paging DRX can be transmitted to gNB by AMF, using the paging information elements, in the RedCap paging DRX field. The gNB can use the information received from the paging message to calculate the PFs and POs where the paging message is transmitted. In another implementation, the gNB can transmit a RedCap specific DRX field with a RAN configuration update message, responsible for updating the RedCap devices specific paging DRX value at the AMF. The usage of the message can avoid the signalling overload sent from the RedCap devices, to inform the AMF related to the updated device paging DRX.

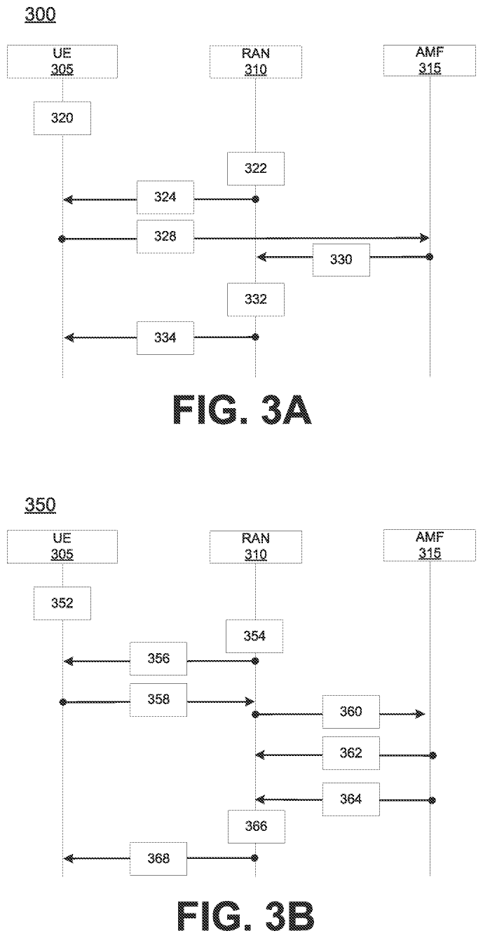

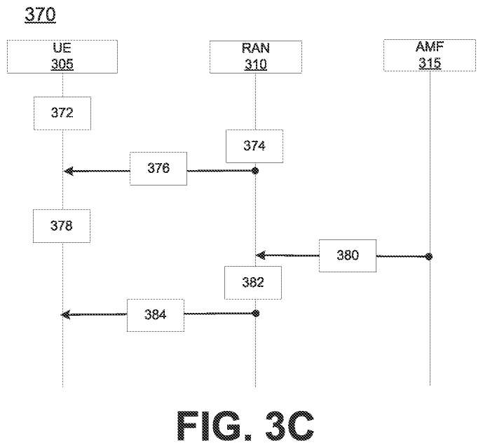

FIGS. 3A, 3B and 3C are flow diagrams illustrating a DRX modification in a network according to an example embodiment. As shown in FIGS. 3A and 3B, network nodes in the network 300, 350 can include a RAN 310 and an AMF 315. The networks 300, 350 can also include a plurality UE's, shown as UE 305 that is within a cell associated with the RAN 310. Although a RAN is illustrated, a BS, an eNB or other network node can be used. In block 320 the UE 305 is switched to an inactive state (e.g., RRC-Inactive) or has been in the inactive state (e.g., RRC-Inactive).

In block 322 the RAN 310 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 322, in response to the indication of a reduced resource state the RAN 310 can trigger a conditional DRX and broadcasts the conditional device paging DRX message to increase the device paging DRX cycle. Alternatively, the trigger can reset the default device-specific paging DRX cycle.

In block 324 the RAN 310 can communicate a message to the UE 305. The message can indicate a device DRX paging configuration for the UE 305. The device DRX paging configuration can include the paging DRX cycle. In an implementation (reduced resource state), the RAN 310 can broadcast a message (e.g., to all devices within a range or cell) with the conditional device paging DRX indication causing the DRX cycle (e.g., time between pages) to increase. In another implementation (returning to the normal state), the RAN 310 can broadcast a message (e.g., to all devices within a range or cell) with the conditional device paging DRX indication causing the DRX cycle (e.g., time between pages) to decrease, return to a default, or previous configuration. The UE 305 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value.

In block 328 the UE 305 communicates a message to the AMF 315. The message can be an attach/TAO procedure. In block 330, the AMF 315 communicates a message to the RAN 310. The message can be a paging message including parameters (e.g., the paging cycle associated with UE 305). In block 332 the RAN 310 can calculate the PF and PO. In block 334 the RAN 310 begins RRC paging using the paging cycle.

Turning to network 350 and FIG. 3B, in block 352 the UE 305 is switched to an Inactive state (e.g., RRC-Inactive) or has been in the Inactive state (e.g., RRC-Inactive). In block 354 the RAN 310 detects and/or determines that at least one of an environmental condition and an operating condition of the network node indicates reduced resource state associated with the network node, or returning to the normal state. For example, a reduced resource is determined if at least one of the UE needs to use a higher coding or modulation rate, the network has limited amount of radio resources, and the network has limited backhaul resources. In block 354, in response to the indication of a reduced resource state the RAN 310 can trigger a conditional DRX and broadcasts the conditional device paging DRX message to increase the device paging DRX cycle. Alternatively, the trigger can reset the default device-specific paging DRX cycle.

In block 356 the RAN 310 can communicate a message to the UE 305. The message can indicate a device DRX paging configuration for the UE 305. The device DRX paging configuration can include the paging DRX cycle. In an implementation (reduced resource state), the RAN 310 can broadcast a message (e.g., to all devices within a range or cell) with the conditional device paging DRX indication causing the DRX cycle (e.g., time between POs) to increase. In another implementation (returning to the normal state), the RAN 310 can broadcast a message (e.g., to all devices within a range or cell) with the conditional device paging DRX indication causing the DRX cycle (e.g., time between POs) to decrease, return to a default, or previous configuration. The UE 305 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value. In block 358 the UE 305 communicates an acknowledgement (ACK) of the indication of the device DRX paging configuration to the RAN 310.

In block 360 the RAN 310 can communicate a message to the AMF 315. The message can be a RAN configuration update message. The RAN configuration update message can include a field associated with RedCap device DRX configuration. In block 362 the AMF can communicate a message to the RAN 310. The message can be a RAN configuration update acknowledge message.

In block 364, the AMF 315 communicates a message to the RAN 310. The message can be a paging message including parameters (e.g., the paging cycle associated with UE 305). In block 366 the RAN 310 can calculate the PF and PO. In block 368 the RAN 310 begins RRC paging using the paging cycle.

Turning to network 370 and FIG. 3C, in block 372 the UE 305 is switched to an Inactive state (e.g., RRC-Inactive) or has been in the Inactive state (e.g., RRC-Inactive). In block 374 the RAN 310 detects and/or determines that at least one of an environmental condition or an operating condition of the network node indicates reduced resource state associated with the network node, or returning to the normal state. For example, a reduced resource determined if at least one of UE needs to use a higher coding or modulation rate, the network has limited amount of radio resources, and the network has limited backbone resources. In block 374, in response to the indication of a reduced resource state the RAN 310 can trigger a conditional DRX and broadcasts the conditional device paging DRX message to increase the device paging DRX cycle. Alternatively, the trigger can reset the default device-specific paging DRX cycle.

In block 376 the RAN 310 can communicate a message to the UE 305. The message can indicate a device DRX paging configuration for the UE 305. The device DRX paging configuration can include the paging DRX cycle. In an implementation (reduced resource state), the RAN 310 can broadcast a message (e.g., to all devices within a range or cell) with the conditional device paging DRX indication causing the DRX cycle (e.g., time between POs) to increase. In another implementation (returning to the normal state), the RAN 310 can broadcast a message (e.g., to all devices within a range or cell) with the conditional device paging DRX indication causing the DRX cycle (e.g., time between POs) to decrease, return to a default, or previous configuration. The UE 305 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value.

In block 378 the UE 305 does not receive the broadcast message. Therefore, the UE 305 does not update the UE 305 paging DRX cycle. The UE 305 continues without updating paging DRX cycle and continues monitoring the PDCCH channels in PFs and POs defined by the current selected device paging DRX cycle. Even if the RAN pages less often, the UE 305 should continue to receive pages even though in some cycles, no page intended for UE 305 could be broadcast. In other words, the UE 305 can initiate some RRC Resume procedure without receiving a page. In block 380, the AMF 315 communicates a message to the RAN 310. The message can be a paging message including parameters (e.g., the paging cycle associated with UE 305). In block 382 the RAN 310 can calculate the PFs and POs. In block 384 the RAN 310 begins RRC paging using the paging cycle.

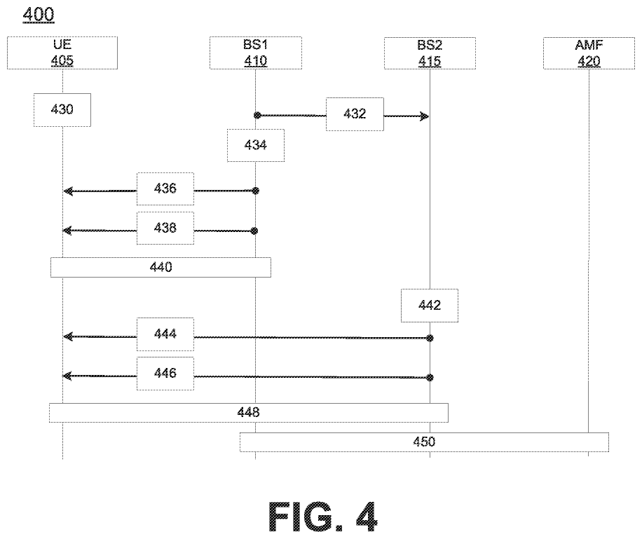

FIGS. 4, 5 and 6 are flow diagrams illustrating a DRX modification in a network according to an example embodiment. illustrate the signaling diagram for the RAN paging when the last serving gNB or another gNB in the RAN Tracking Area (RTA) list, triggers an update of the device paging DRX cycle. In response to detection of the congestion in the cell, degradation of channel quality, low battery level of the devices, or returning to the normal state. As shown in FIG. 4, network nodes in the network 400, can include a BS1 410, a BS2 415, and an AMF 420. The network 400 can also include a plurality UE's, shown as UE 405 that is within a cell associated with one of the BS1 410 or the BS2 420. Although a BS is illustrated, a RAN, an eNB or other network node can be used. In block 430 the UE 405 is switched to an Inactive state (e.g., RRC-Inactive) or has been in the Inactive state (e.g., RRC-Inactive). In this implementation, BS1 410 can be the last serving BS for the UE 405 and BS2 415 can be a BS in the RTA list.

In block 430 the UE 405 is switched to an Inactive state (e.g., RRC-Inactive) or has been in the Inactive state (e.g., RRC-Inactive). In block 432 the BS1 410 can communicate a message to BS2 415. The message can be an XnAP paging message. The message can include a default device specific DRX paging configuration.

In block 434 the BS1 410 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backhaul resources. In block 434, in response to the indication of a reduced resource state the BS1 410 can trigger a conditional DRX and broadcasts the conditional device paging DRX message to increase the device paging DRX cycle. Alternatively, the trigger can reset the default device-specific paging DRX cycle.

In block 436 the BS1 410 can communicate a message to the UE 405. The message can indicate a device DRX paging configuration for the UE 405. The device DRX paging configuration can include the paging DRX cycle. In an implementation (reduced resource state), the BS1 410 can broadcast a message (e.g., to all devices within a range or cell) with the conditional device paging DRX indication causing the DRX cycle (e.g., time between POs) to increase. In another implementation (returning to the normal state), the BS1 410 can broadcast a message (e.g., to all devices within a range or cell) with the conditional device paging DRX indication causing the DRX cycle (e.g., time between POs) to decrease, return to a default, or previous configuration. The UE 405 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value.

In block 438 the BS1 410 begins RRC paging using the paging cycle. In block 440 a random access for paging response between the UE 405 and the BS1 410 begins. However, UE 405 may no longer be located in the cell associated with BS1 410. Therefore, another BS in the RTA list should page the UE 405 (assuming that UE 405 is in a cell associated with a BS in the RTA list).

In block 442 the BS2 415 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 442, in response to the indication of a reduced resource state the BS2 415 can trigger a conditional DRX and broadcasts the conditional device paging DRX message to increase the device paging DRX cycle. Alternatively, the trigger can reset the default device-specific paging DRX cycle.

In block 444 the BS2 415 can communicate a message to the UE 405. The message can indicate a device DRX paging configuration for the UE 405. The device DRX paging configuration can include the paging DRX cycle. In an implementation (reduced resource state), the BS2 415 can broadcast a message (e.g., to all devices within a range or cell) with the conditional device paging DRX indication causing the DRX cycle (e.g., time between POs) to increase. In another implementation (returning to the normal state), the BS2 415 can broadcast a message (e.g., to all devices within a range or cell) with the conditional device paging DRX indication causing the DRX cycle (e.g., time between POs) to decrease, return to a default, or previous configuration. The UE 405 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value. In block 446 the BS2 415 begins RRC paging using the paging cycle because UE 405 is camping in the cell associated with BS2 415. In block 448 a random access for paging response between the UE 405, the BS1 410 and the BS2 415 begins. In block 450 context fetching and data forwarding to the BS where the UE paging response is received (a path switch) commences between BS1 410, BS2 415 and AMF 420.

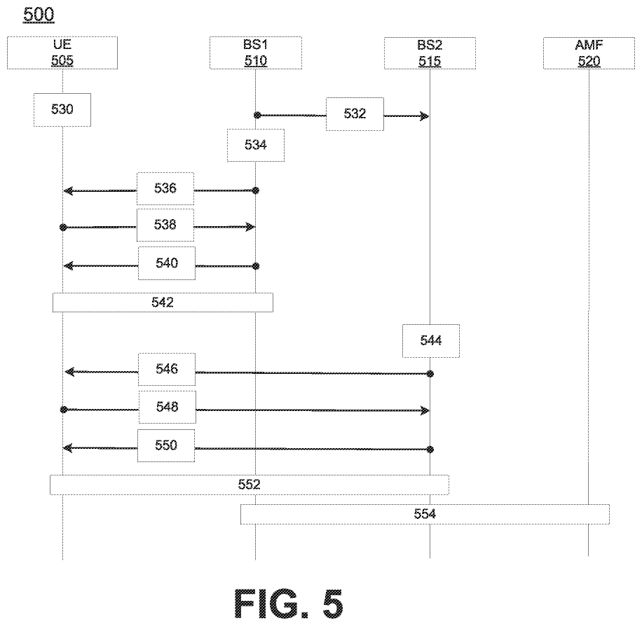

Turning to FIG. 5, network nodes in the network 500, can include a BS1 510, a BS2 515, and an AMF 520. The network 500 can also include a plurality UE's, shown as UE 505 that is within a cell associated with one of the BS1 510 or the BS2 520. Although a BS is illustrated, a RAN, an eNB or other network node can be used. In block 530 the UE 505 is switched to an Inactive state (e.g., RRC-Inactive) or has been in the Inactive state (e.g., RRC-Inactive). In this implementation, BS1 510 can be the last serving BS for the UE 505 and BS2 515 can be a BS in the RTA list.

In block 530 the UE 505 is switched to an Inactive state (e.g., RRC-Inactive) or has been in the Inactive state (e.g., RRC-Inactive). In block 532 the BS1 510 can communicate a message to BS2 515. The message can be an XnAP paging message. The message can include a default device specific DRX paging configuration.

In block 534 the BS1 510 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 534, in response to the indication of a reduced resource state the BS1 510 can trigger a conditional DRX and broadcasts the conditional device paging DRX message to increase the device paging DRX cycle. Alternatively, the trigger can reset the default device-specific paging DRX cycle.

In block 536 the BS1 510 can communicate a message to the UE 505. The message can indicate a device DRX paging configuration for the UE 505. The device DRX paging configuration can include the paging DRX cycle. In an implementation (reduced resource state), the BS1 510 can broadcast a message (e.g., to all devices within a range or cell) with the conditional device paging DRX indication causing the DRX cycle (e.g., time between POs) to increase. In another implementation (returning to the normal state), the BS1 510 can broadcast a message (e.g., to all devices within a range or cell) with the conditional device paging DRX indication causing the DRX cycle (e.g., time between POs) to decrease, return to a default, or previous configuration. The UE 505 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value. In block 538 the UE 505 communicates an acknowledgement (ACK) of the indication of the device DRX paging configuration to the BS1 510.

In block 540 the BS1 510 begins RRC paging using the paging cycle. In block 542 a random access for paging response between the UE 505 and the BS1 510 begins. However, UE 505 may no longer be located in the cell associated with BS1 510. Therefore, another BS in the RTA list should page the UE 505 (assuming that UE 505 is in a cell associated with a BS in the RTA list).

In block 544 the BS2 515 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 544, in response to the indication of a reduced resource state the BS2 515 can trigger a conditional DRX and broadcasts the conditional device paging DRX message to increase the device paging DRX cycle. Alternatively, the trigger can reset the default device-specific paging DRX cycle.

In block 546 the BS2 515 can communicate a message to the UE 505. The message can indicate a device DRX paging configuration for the UE 505. The device DRX paging configuration can include the paging DRX cycle. In an implementation (reduced resource state), the BS2 515 can broadcast a message (e.g., to all devices within a range or cell) with the conditional device paging DRX indication causing the DRX cycle (e.g., time between POs) to increase. In another implementation (returning to the normal state), the BS2 515 can broadcast a message (e.g., to all devices within a range or cell) with the conditional device paging DRX indication causing the DRX cycle (e.g., time between POs) to decrease, return to a default, or previous configuration. The UE 505 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value. In block 548 the UE 505 communicates an acknowledgement (ACK) of the indication of the device DRX paging configuration to the BS2 515. In block 550 the BS2 515 begins RRC paging using the paging cycle because UE 505 is camping in the cell associated with BS2 515. In block 552 a random access for paging response between the UE 505, the BS1 510 and the BS2 515 begins. In block 554 context fetching and data forwarding to the BS where the UE paging response is received (a path switch) commences between BS1 510, BS2 515 and AMF 520.

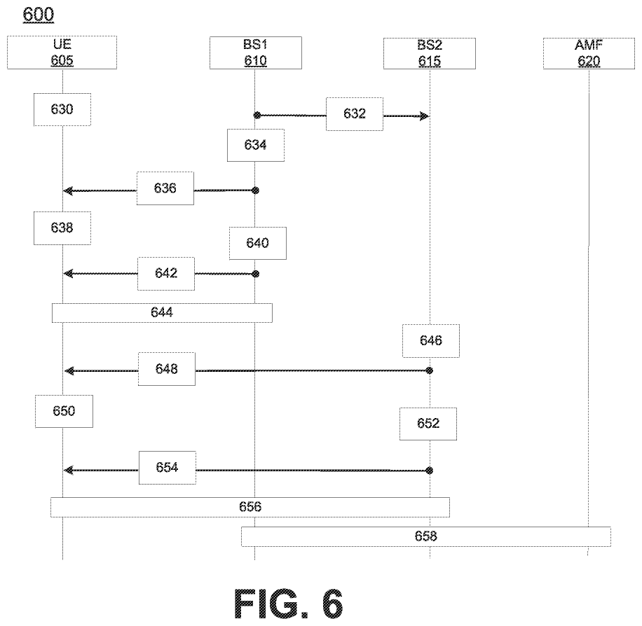

Turning to FIG. 6, network nodes in the network 600, can include a BS1 610, a BS2 615, and an AMF 620. The network 600 can also include a plurality UE's, shown as UE 605 that is within a cell associated with one of the BS1 610 or the BS2 620. Although a BS is illustrated, a RAN, an eNB or other network node can be used. In this implementation, BS1 610 can be the last serving BS for the UE 605 and BS2 615 can be a BS in the RTA list.

In block 630 the UE 605 is switched to an Inactive state (e.g., RRC-Inactive) or has been in the Inactive state (e.g., RRC-Inactive). In block 632 the BS1 610 can communicate a message to BS2 615. The message can be an XnAP paging message. The message can include a default device specific DRX paging configuration.

In block 634 the BS1 610 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 634, in response to the indication of a reduced resource state the BS1 610 can trigger a conditional DRX and broadcasts the conditional device paging DRX message to increase the device paging DRX cycle. Alternatively, the trigger can reset the default device-specific paging DRX cycle.

In block 636 the BS1 610 can communicate a message to the UE 605. The message can indicate a device DRX paging configuration for the UE 605. The device DRX paging configuration can include the paging DRX cycle. In an implementation (reduced resource state), the BS1 610 can broadcast a message (e.g., to all devices within a range or cell) with the conditional device paging DRX indication causing the DRX cycle (e.g., time between pages) to increase. In another implementation (returning to the normal state), the BS1 610 can broadcast a message (e.g., to all devices within a range or cell) with the conditional device paging DRX indication causing the DRX cycle (e.g., time between pages) to decrease, return to a default, or previous configuration. The UE 605 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value.

In block 638 the UE 605 does not receive the broadcast message. Therefore, the UE 605 does not update the UE 605 paging DRX cycle. The UE 605 continues without the update paging DRX cycle and continues monitoring the PDCCH channels in PFs and POs defined by the current selected device paging DRX cycle. Even if the RAN pages less often, the UE 605 should continue to receive pages even though in some cycles, no page intended for UE 605 was broadcast. In other words, the UE 605 can initiate some RRC Resume procedure without receiving a page. In block 640 no feedback associated with the decreased DRX paging rate is received. Therefore, the BS1 610 continues DRX paging at the original (e.g., increased) paging rate.

In block 642 the BS1 610 begins RRC paging using the paging cycle. In block 644 a random access for paging response between the UE 605 and the BS1 610 begins. However, UE 605 may no longer be located in the cell associated with BS1 610. Therefore, another BS in the RTA list should page the UE 605 (assuming that UE 605 is in a cell associated with a BS in the RTA list.

In block 646 the BS2 615 detects and/or determines that at least one of an environmental condition and an operating condition of the network node indicates reduced resource state associated with the network node, or returning to the normal state. For example, a reduced resource is determined if at least one of UE needs to use a higher coding or modulation rate, the network has limited amount of radio resources, and the network has limited backbone resources. In block 648, in response to the indication of a reduced resource state the BS2 615 can trigger a conditional DRX and broadcasts the conditional device paging DRX message to increase the device paging DRX cycle. Alternatively, the trigger can reset the default device-specific paging DRX cycle.

In block 648 the BS2 615 can communicate a message to the UE 605. The message can indicate a device DRX paging configuration for the UE 605. The device DRX paging configuration can include the paging DRX cycle. In an implementation (reduced resource state), the BS2 615 can broadcast a message (e.g., to all devices within a range or cell) with the conditional device paging DRX indication causing the DRX cycle (e.g., time between POs) to increase. In another implementation (returning to the normal state), the BS2 615 can broadcast a message (e.g., to all devices within a range or cell) with the conditional device paging DRX indication causing the DRX cycle (e.g., time between POs) to decrease, return to a default, or previous configuration. The UE 605 can update the paging DRX cycle upon reception of the broadcast message, by selecting a preconfigured device paging DRX cycle, depending on the state specified in the broadcast message, consisting in increasing the device paging DRX cycle or reverting the device paging DRX cycle to the default value.

In block 650 the UE 605 does not receive the broadcast message. Therefore, the UE 605 does not update the UE 605 paging DRX cycle. The UE 605 continues without the update paging DRX cycle and continues monitoring the PDCCH channels in PFs and POs defined by the current selected device paging DRX cycle. Even if the BS2 615 pages less often, the UE 605 should continue to receive pages even though in some cycles, no page intended for UE 605 was broadcast. In other words, the UE 605 can initiate some RRC Resume procedure without receiving a page. In block 652 no feedback associated with the decreased DRX paging rate is received. Therefore, the BS2 615 continues DRX paging at the original (e.g., increased) paging rate.

In block 654 the BS2 615 begins RRC paging using the paging cycle. In block 656 a random access for paging response between the UE 605 and the BS2 615 begins. In block 658 context fetching and data forwarding to the BS where the UE paging response is received (a path switch) commences between BS1 610, BS2 615 and AMF 620.

Example implementations can extent the battery life and/or extent the maintaining of a charge of a battery by decreasing unnecessary use of radio resources through postponing of paging messages to ideal times. However, there can be additional benefits to avoid paging the UE. For example, reducing PRACH overloading or congestion. When the cell is congested, mechanisms to avoid and resolve the congestion are activated depending on the direction of the data transmission. Cell Barring and Reservation and Unified Access Control mechanisms restrict the devices from accessing the cell at the earliest stages. When downlink data needs to be transmitted, gNB uses paging control mechanisms to avoid paging messages transmission when the cell is congested. In case devices access congested cells, state of the art mechanisms, such as device-specific back off schemes are used, to solve the congestion.

The focus of the above mechanism is to avoid or resolve the congestion in the cell, without considering the energy consumption on the device side. As a result, even though the gNB decides not to send a paging message, the device consumes energy during the PDCCH channel monitoring. Otherwise, the device consumes energy due to the collision during the RACH procedure which can reducing core network (CN) paging overhead, when resources are not available. AMF sends a CN paging for devices and waits for a Service Request message transmitted from devices after executing the RACH procedure. AMF starts T3513 timer while it waits. When PRACH preambles are not available, devices need to repeat multiple times the RRC Resume procedure. Additionally, the lack of radio resources is accompanied by an RRC Reject or RRC Release answer with a Wait Timer. The Wait Timer defines the time the device has to wait before starting again the RACH procedure. In the meanwhile, if the T3513 timer expires, the AMF will retransmit the paging message to the gNB, causing a paging overhead. On the device side, the continuous triggering to resume the connection, when resources are not available, it increases further the energy consumption.

Besides, the state of the cell resources, the context information of the environment and the devices affect the device consumed energy. For example, channel quality degradation. Even though the channel quality throughout the cell has degraded due to various reasons (e.g., weather conditions), the cell will transmit the paging message in the calculated PFs and POs, causing the device to transition to RRC-Connected state. However, due to the bad channel quality, the downlink transmission might be erroneous, causing multiple transmissions and increasing the device energy consumption. For example, continuously changing of the battery life of the device. RedCap devices might be gathered in groups, with similar device conditions, such as the battery level and application type. When devices have a low battery level, having PFs and POs very frequent causes a fast decrease in the battery level of the devices. On the other side, a high battery level and an application which expects downlink data transmitted frequently will require frequent PFs and POs. Therefore, a battery level threshold can be applied to differentiate between the low battery level or normal battery level states. If the majority of the group devices reach a lower battery level than the threshold, gNB will get informed by one of the devices about the battery level state of the group.

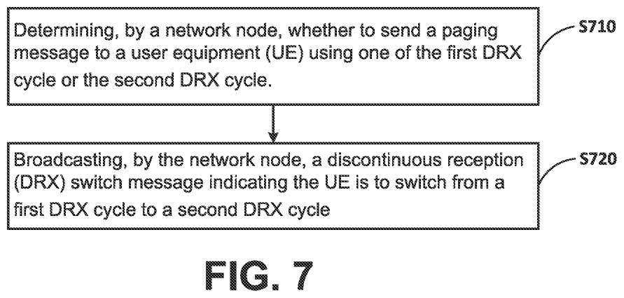

Example 1. FIG. 7 is a block diagram of a method of operating a network node or network device in communication with a user equipment (UE). The method including, in step S710, broadcasting, by the network node, a discontinuous reception (DRX) switch message indicating the UE is to switch from a first DRX cycle to a second DRX cycle. In step S720 determining, by the network node, whether to send a paging message to the UE using one of the first DRX cycle or the second DRX cycle.

Example 2. The method of Example 1 can further include determining, by the network node, that the network node is in a reduced resource state.

Example 3. The method of Example 2, wherein the reduced resource can include at least one of a resource unavailability to support a required coding or modulation rate for communication with the UE, the network having a limited amount of radio resources, and the network having limited backhaul resources.

Example 4. The method of any of Example 1 to Example 3 can further include receiving, by the network node, an indication that the UE is configured to monitor the paging message using the second DRX cycle.

Example 5. The method of Example 4, wherein the network node can be a radio access network (RAN) node or a mobility management function (AMF).

Example 6. The method of Example 4, wherein the indication that the UE is configured to monitor the paging message using the second DRX cycle can be received from the UE as an ACK message.

Example 7. The method of Example 4, wherein the indication that the UE is configured to monitor the paging message using the second DRX cycle can be received at an AMF as one of a configuration update message.

Example 8. The method of Example 4, wherein the indication that the UE is configured to monitor the paging message using the second DRX cycle can be received at an AMF as a UE context update message.

Example 9. The method of any of Example 1 to Example 8, wherein the DRX switch message can be a first DRX switch message, the method can further include determining, by the network node, that the network node is no longer in a reduced resource state and broadcasting, by the network node, a second DRX switch message indicating the UE is to switch from the second DRX cycle to the first DRX cycle.

Example 10. The method of any of Example 1 to Example 9, wherein the DRX switch message can be a first DRX switch message, the method can further include determining, by the network node, whether the UE has received one of the first DRX switch message or a second DRX switch message, determining, by the network node, whether the UE is monitoring the paging message using the first DRX cycle or the second DRX cycle, in response to determining the UE is using the second DRX cycle, the sending of the paging message to the UE uses the second DRX cycle, in response to determining the UE is using the first DRX cycle, the sending of the paging message to the UE uses the first DRX cycle, and rebroadcasting, by the network node, one of the first DRX switch message indicating the UE is to switch from the first DRX cycle to the second DRX cycle or the second DRX message indicating the UE is to switch from the second DRX cycle to the first DRX cycle.

Example 11. The method of any of Example 1 to Example 10, wherein the broadcasting of the first DRX switch message or the second DRX switch message can include sending a message indicated as part of a system information update indication.

Example 12. The method of any of Example 1 to Example 11, wherein the first DRX cycle and the second DRX cycle can be preconfigured in the UE by the network node while the UE is in an RRC active state.

Example 13. The method of any of Example 1 to Example 12, wherein the UE can be pre-configured to monitor the DRX switch message.

Example 14. The method of any of Example 1 to Example 13, can further include communicating, to an AMF, that the UE has switched to the second DRX.

Example 15. A non-transitory computer-readable storage medium comprising instructions stored thereon that, when executed by at least one processor, are configured to cause a computing system to perform the method of any of Examples 1-14.

Example 16. An apparatus comprising means for performing the method of any of Examples 1-14.

Example 17. An apparatus comprising at least one processor and at least one memory including computer program code, the at least one memory and the computer program code configured to, with the at least one processor, cause the apparatus at least to perform the method of any of Examples 1-14.

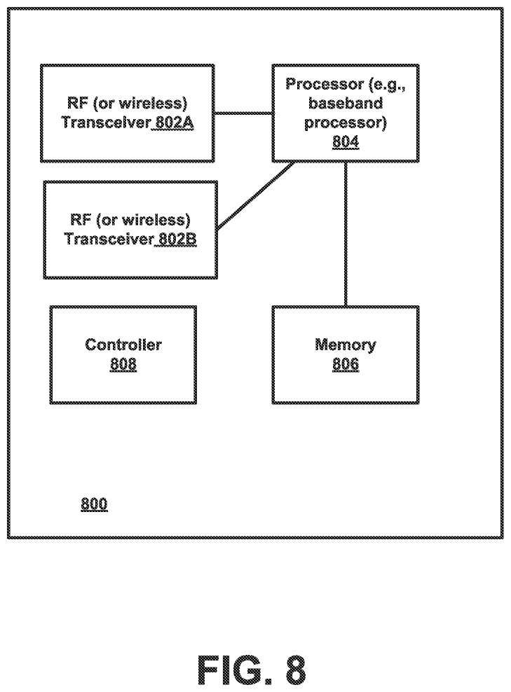

FIG. 8 is a block diagram of a wireless station 800 or wireless node or network node 800 according to an example embodiment. The wireless node or wireless station or network node 800 may include, e.g., one or more of an AP, BS, gNB, RAN node, relay node, UE or user device, network node, network entity, DU, CU-CP, CU-UP, . . . or other node) according to an example embodiment.

The wireless station 800 may include, for example, one or more (e.g., two as shown in FIG. 8) radio frequency (RF) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example embodiment, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-56. (canceled)

57. An apparatus comprising means for:
broadcasting, by a network node, a discontinuous reception (DRX) switch message indicating a user equipment (UE) is to switch from a first DRX cycle to a second DRX cycle; and
determining, by the network node, whether to send a paging message to the UE using one of the first DRX cycle or the second DRX cycle.

58. The apparatus of claim 57, further comprising at least one of:
determining, by the network node, that the network node is in a reduced resource state, or
means for receiving, by the network node, an indication that the UE is configured to monitor the paging message using the second DRX cycle.

59. The apparatus of claim 58, wherein the reduced resource comprises at least one of a resource unavailability to support a required coding or modulation rate for communication with the UE, the network having a limited amount of radio resources, and the network having limited backhaul resources.

60. The apparatus of claim 58, wherein the network node is a radio access network (RAN) node or a mobility management function (AMF).

61. The apparatus of claim 58, wherein the indication that the UE is configured to monitor the paging message using the second DRX cycle is received from the UE as an ACK message.

62. The apparatus of claim 58, wherein at least one of:
the indication that the UE is configured to monitor the paging message using the second DRX cycle is received at an AMF as a configuration update message, or
the indication that the UE is configured to monitor the paging message using the second DRX cycle is received at an AMF as a UE context update message.

63. The apparatus of claim 57, wherein the DRX switch message is a first DRX switch message, the apparatus further comprising means for:
determining, by the network node, that the network node is no longer in a reduced resource state; and
broadcasting, by the network node, a second DRX switch message indicating the UE is to switch from the second DRX cycle to the first DRX cycle.

64. The apparatus of claim 57, wherein the DRX switch message is a first DRX switch message, the apparatus further comprising means for:
determining, by the network node, whether the UE has received one of the first DRX switch message or a second DRX switch message;
determining, by the network node, whether the UE is monitoring the paging message using the first DRX cycle or the second DRX cycle;
in response to determining the UE is using the second DRX cycle, the sending of the paging message to the UE uses the second DRX cycle;
in response to determining the UE is using the first DRX cycle, the sending of the paging message to the UE uses the first DRX cycle; and
rebroadcasting, by the network node, one of the first DRX switch message indicating the UE is to switch from the first DRX cycle to the second DRX cycle or the second DRX message indicating the UE is to switch from the second DRX cycle to the first DRX cycle.

65. The apparatus of claim 57, wherein the broadcasting of the first DRX switch message or the second DRX switch message comprises sending a message indicated as part of a system information update indication.

66. The apparatus of claim 57, wherein the first DRX cycle and the second DRX cycle are preconfigured in the UE by the network node while the UE is in an RRC active state.

67. The apparatus of claim 57, wherein the UE is pre-configured to monitor the DRX switch message.

68. The apparatus of claim 57, further comprising means for communicating, to an AMF, that the UE has switched to the second DRX cycle.

69. An apparatus comprising:
at least one processor; and
at least one memory including computer program code;
the at least one memory and the computer program code configured to, with the at least one processor, cause the apparatus to:
broadcast, by a network node, a discontinuous reception (DRX) switch message indicating a user equipment (UE) is to switch from a first DRX cycle to a second DRX cycle; and
determine, by the network node, whether to send a paging message to the UE using one of the first DRX cycle or the second DRX cycle.

70. The apparatus of claim 69, the computer program code further causes the apparatus to determine, by the network node, that the network node is in a reduced resource state.

71. The apparatus of claim 70, wherein the reduced resource comprises at least one of a resource unavailability to support a required coding or modulation rate for communication with the UE, the network having a limited amount of radio resources, and
the network having limited backhaul resources.

72. The apparatus of claim 69, wherein at least one of:
the computer program code further causes the apparatus to receive, by the network node, an indication that the UE is configured to monitor the paging message using the second DRX cycle, or
the network node is a radio access network (RAN) node or a mobility management function (AMF).

73. The apparatus of claim 72, wherein at least one of:
the indication that the UE is configured to monitor the paging message using the second DRX cycle is received from the UE as an ACK message, or
the indication that the UE is configured to monitor the paging message using the second DRX cycle is received at an AMF as a configuration update message, or
the indication that the UE is configured to monitor the paging message using the second DRX cycle is received at an AMF as a UE context update message.

74. The apparatus of claim 69, wherein the DRX switch message is a first DRX switch message, the computer program code further causes the apparatus to:
determine, by the network node, that the network node is no longer in a reduced resource state; and
broadcast, by the network node, a second DRX switch message indicating the UE is to switch from the second DRX cycle to the first DRX cycle.

75. The apparatus of claim 69, wherein the DRX switch message is a first DRX switch message, the computer program code further causes the apparatus to:
determine, by the network node, whether the UE has received one of the first DRX switch message or a second DRX switch message;
determine, by the network node, whether the UE is monitoring the paging message using the first DRX cycle or the second DRX cycle;
in response to determining the UE is using the second DRX cycle, the sending of the paging message to the UE uses the second DRX cycle;
in response to determining the UE is using the first DRX cycle, the sending of the paging message to the UE uses the first DRX cycle; and
rebroadcast, by the network node, one of the first DRX switch message indicating the UE is to switch from the first DRX cycle to the second DRX cycle or the second DRX message indicating the UE is to switch from the second DRX cycle to the first DRX cycle.

76. The apparatus of claim 69, wherein at least one of:
the broadcasting of the first DRX switch message or the second DRX switch message comprises sending a message indicated as part of a system information update indication, or
the first DRX cycle and the second DRX cycle are preconfigured in the UE by the network node while the UE is in an RRC active state, or
the UE is pre-configured to monitor the DRX switch message, or
the computer program code further causes the apparatus to communicate, to an AMF, that the UE has switched to the second DRX cycle.
